(19) United States
(12) Patent Application Publication
(10) Pub. No.: US 2019/0048846 A1
(43) Pub. Date: Feb. 14, 2019

(54) Hydrokinetic Turbine Having Helical Tanks

(71) Applicant: GT Hydrokinetic, LLC, Memphis, TN (US)

(72) Inventors: John I. Hochstein, Germantown, TN (US); Geoffrey B. Greene, Memphis, TN (US)

(73) Assignee: GT Hydrokinetic, LLC, Memphis, TN (US)

(21) Appl. No.: 16/053,567

(22) Filed: Aug. 2, 2018

Related U.S. Application Data
(60) Provisional application No. 62/543,538, filed on Aug. 10, 2017.

(51) Int. Cl. F03B 17/06; F03B 7/00; H02K 5/22; H02K 7/18; H02K 7/20; H02K 13/00

(52) U.S. Cl. CPC F03B 17/061; F03B 7/00; H02K 5/225; H02K 7/1823; H02K 7/20; F05B 2240/93; F05B 2220/706; F05B 2240/24; F05B 2250/25; F05B 2210/11; F05B 2240/95; H02K 13/003

(57) ABSTRACT

A hydrokinetic energy system for producing electricity is provided. The system represents a hydrokinetic water turbine having a tubular body and an internal turbine that resides within a central pipe of the turbine. The tubular body is helix-like in shape and slowly rotates in a body of water in response to water currents. The tubular body includes two or more tanks of internal working fluid that is fluidically isolated from the body of water. Slow rotation of the turbine wheel produces a gravitational flow of internal working fluid through the tanks within the turbine. The gravitational flow of fluid turns the internal turbine at a high speed to generate electrical power. A method of generating electrical power using a hydrokinetic water turbine is also provided.

### STATEMENT OF RELATED APPLICATIONS

This application claims the benefit of U.S. Ser. No. 62/543,538 filed Aug. 10, 2017. That application is entitled “Large Water Turbine Having Helical Hydrokinetic Tanks” and is incorporated herein in its entirety by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce selected aspects of the art, which may be associated with various embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present disclosure relates to the field of energy generation. More specifically, the present disclosure relates to the generation of electrical energy through hydrokinetic flow through a large body of water. The present disclosure further relates to a dual turbine wherein the dual turbine comprises at least one tubular helical body forming a closed fluid circuit.

### Discussion of Technology

Naturally occurring fluid motion such as that found in wind and water currents contains kinetic energy that can be harnessed for useful consumption. The branch of physics concerned with such fluid motion can be broadly referred to as hydrokinetics.

Hydrokinetics has long been employed by machines, i.e., “water wheels,” that extract energy from falling water to perform useful functions. Such functions include grinding wheat and running belt-driven factories. More recently, hydrokinetics has been used to generate electricity. Conventional harnessing of hydrokinetic energy to produce electricity employs the use of turbines that are equipped with blades. The turbines are placed within a body of flowing water, which exerts a force on the turbine blades to turn a wheel. The rotation of the wheel produces a resultant torque that, in turn, is used to directly rotate an output shaft for driving a generator to produce electricity.

Those of ordinary skill in the art will appreciate that the amount of power that can be harnessed from a water wheel increases proportionally with the diameter of the wheel squared. Thus, large wheels generate significantly more power than small wheels. For example, increasing a turbine wheel diameter by a factor of 10 increases the power output by a factor of 100. Thus, assuming an efficiency of 100%, a water wheel that is forty feet in diameter has the capacity to produce the same amount of power as 100 wheels that are four feet in diameter.

Although larger water wheels are capable of producing more power, the rotational speed of a water wheel decreases as the diameter of the water wheel increases. For instance, doubling the diameter of a water wheel causes a reciprocal reduction in the rotational speed by one half. This has an effect on the power output.

Horsepower may be mathematically defined as:

HP=(T*RPM)/5,252

where HP=Horsepower;
T=Torque
RPM=Revolutions Per Minute

Rearranging the HP equation to solve for torque gives:

T=(5,252*HP)/RPM.

It can be seen that as RPM decreases, torque, or the force required to turn the working shaft, increases.

Hence, although doubling the diameter of a water wheel or turbine increases the power output by a factor of four, the associated reduction in rotational speed means that the torque increases by a factor of eight. Stated another way, with increasing turbine size, the influences of heightened power levels and decreasing rotational speeds synergistically contribute to a need to produce large amounts of torque. The resultant torque load makes power transmission through large turbines more difficult and less efficient, particularly when substantial power output is required.

As power output reaches useful levels, such as 100,000 watts (which is equal to 134 HP) the torque generated requires very large, expensive mechanical gears to increase the RPM to a level that is capable of driving a useful generator.

The following chart illustrates the relationship between area, maximum wattage, maximum HP, revolutions per minute, and torque for various diameters of water wheels. This chart was calculated assuming an efficiency of 100%. While 100% efficiency is not currently achievable, the chart demonstrates the difficulties involved in using hydrokinetic energy to produce usable power. The torque quickly becomes unmanageable as useful power levels are achieved.

| Water Wheel | Water | Max. Power | | | |
|---|---|---|---|---|---|
| Diameter | Wheel Area | Input | Max. HP | Revolutions | Torque |
| (feet) | (ft²) | (Watts) | Input | Per Minute | (ft-lbs) |
| 1 | 0.785398 | 406.8362 | 0.545357 | 139.9927 | 20.45974 |
| 2 | 3.141593 | 1,627.345 | 2.181428 | 69.99634 | 163.6779 |
| 3 | 7.068583 | 3,661.526 | 4.908212 | 46.66423 | 552.4131 |
| 4 | 12.56637 | 6,509.38 | 8.72571 | 34.99817 | 1,309.424 |
| 5 | 19.63495 | 10,170.91 | 13.63392 | 27.99854 | 2,557.468 |
| 6 | 28.27433 | 14,646.1 | 19.63285 | 23.33211 | 4,419.305 |
| 7 | 38.48451 | 19,934.98 | 26.72249 | 19.99896 | 7,017.692 |
| 8 | 50.26548 | 26,037.52 | 34.90284 | 17.49909 | 10,475.39 |
| 9 | 63.61725 | 32,953.74 | 44.17391 | 15.55474 | 14,915.15 |
| 10 | 78.53982 | 40,683.62 | 54.53569 | 13.99927 | 20,459.74 |
| 11 | 95.03318 | 49,227.19 | 65.98819 | 12.72661 | 27,231.92 |
| 12 | 113.0973 | 58,584.42 | 78.53139 | 11.66606 | 35,354.44 |
| 13 | 132.7323 | 68,755.33 | 92.16532 | 10.76867 | 44,950.06 |
| 14 | 153.938 | 79,739.9 | 106.89 | 9.999478 | 56,141.54 |
| 15 | 176.7146 | 91,538.16 | 122.7053 | 9.332846 | 69,051.63 |
| 16 | 201.0619 | 104,150.1 | 139.6114 | 8.749543 | 83,803.11 |
| 17 | 226.9801 | 117,575.7 | 157.6081 | 8.234864 | 100,518.7 |
| 18 | 254.469 | 131,814.9 | 176.6956 | 7.777372 | 119,321.2 |
| 19 | 283.5287 | 146,867.9 | 196.8738 | 7.368036 | 140,333.4 |
| 20 | 314.1593 | 162,734.5 | 218.1428 | 6.999634 | 163,677.9 |
| 21 | 346.3606 | 179,414.8 | 240.5024 | 6.666318 | 189,477.7 |
| 22 | 380.1327 | 196,908.7 | 263.9527 | 6.363304 | 217,855.3 |
| 23 | 415.4756 | 215,216.4 | 288.4938 | 6.086639 | 248,933.7 |
| 24 | 452.3893 | 234,337.7 | 314.1256 | 5.833029 | 282,835.5 |
| 25 | 490.8739 | 254,272.7 | 340.8481 | 5.599708 | 319,683.5 |
| 26 | 530.9292 | 275,021.3 | 368.6613 | 5.384334 | 359,600.4 |
| 27 | 572.5553 | 296,583.6 | 397.5652 | 5.184914 | 402,709.1 |
| 28 | 615.7522 | 318,959.6 | 427.5598 | 4.999739 | 449,132.3 |
| 29 | 660.5199 | 342,149.3 | 458.6452 | 4.827334 | 498,992.7 |
| 30 | 706.8583 | 366,152.6 | 490.8212 | 4.666423 | 552,413.1 |
| 31 | 754.7676 | 390,969.6 | 524.088 | 4.515893 | 609,516.2 |
| 32 | 804.2477 | 416,600.3 | 558.4455 | 4.374771 | 670,424.9 |

It is assumed that all input power numbers use the same fluid velocity.

As hydrokinetic power generation systems increase in size, conventional systems that rely purely on the mechanical transmission of power from the water turbine to the output shaft encounter increasingly difficult design challenges. Increasingly large and complex mechanical sub systems introduce losses, require maintenance, reduce system reliability, and may jeopardize the economic viability of the system. By way of example from the chart above, a 30-foot diameter turbine wheel immersed in flowing water that rotates at 4.66 RPM has a torque rating of 552,413 foot-pounds. A wheel with such a large torque rating would require an enormous gearbox to drive a generator at an output speed of 1,000 RPM. Such a gear box would be prohibitively cumbersome, expensive, and difficult to fabricate. Thus, use of water wheels or turbines to generate substantial amounts of power with conventional methods is largely impractical.

U.S. Pat. No. 8,763,386 ('386 patent), entitled “Large Water Turbine,” presents one embodiment of a hydrokinetic turbine that attempts to address the torque problem discussed above. The '386 patent is incorporated herein in its entirety by reference

The '386 patent employs a hydrokinetic wheel with an internal working fluid that drives an internal turbine to produce electricity. The wheel includes a hub, and a plurality of tanks equi-radially spaced about the hub. In operation of the wheel, internal working fluid drains gravitationally from the tanks at the top of the wheel and then through an internal turbine. From there, the working fluid drains into tanks at the bottom of the wheel. As the '386 water wheel rotates, the lower tanks, now filled with working fluid, move to the top of the water wheel, and the process is repeated. In this way, the internal turbine turns at a much greater rate as compared to that of the external water wheel, thereby reducing the effect of the torque problem.

It is observed that the '386 patent requires a system with multiple tanks, a number of fluid pipes exiting each tank that feed to a central manifold, and a heavy frame that extends beyond the vanes to support the system of tanks. These aspects result in a cumbersome support structure and a significant increase in the weight of the system, which depletes overall efficiency. Accordingly, a need exists for an improved water turbine having a large diameter wheel with a simple and relatively light frame. A need further exists for a water turbine that is able to generate large amounts of electrical power without any mechanical speed step-up gears and with very few moving parts.

### SUMMARY OF THE INVENTION

A hydrokinetic turbine for producing electricity is provided herein. The hydrokinetic turbine is configured to be submerged in a flowing body of water. Preferably, the hydrokinetic turbine is anchored to an ocean floor or a deep river bed such as through the use of at least two mooring lines. The mooring lines may be anchored directly to the ocean floor or river bed, or may be connected to a buoy that itself is anchored to the ocean floor or river bed.

The diameter of the hydrokinetic turbine may be scaled to any suitable size for the generation of the desired electrical output. The diameter may range from five to fifty feet. In one aspect, the diameter of the hydrokinetic turbine ranges from fifty feet to 250 feet.

In one aspect, the hydrokinetic turbine has a tubular body. Preferably, the tubular body is substantially helical (or helix-like) in shape. Two or more blades extend radially from a central pipe of the tubular body. The two or more blades operate as vanes that are configured to rotate the tubular body at a first speed in response to flowing water. The speed of the tubular body may be expressed as revolutions per minute, or “first RPM value.” The two or more blades reside equi-distantly about the central pipe of the tubular body. Vane supports secure the respective blades to the central pipe. In one aspect, the hydrokinetic turbine includes six or more blades placed radially about the central pipe.

In the hydrokinetic turbine, a volume of internal working fluid resides within the tubular body. Of interest, the central pipe is in fluid communication with the tubular body and forms a closed fluid circuit for the helical tubular body. The working fluid is preferably a clean aqueous fluid having bacterial and corrosion inhibitors.

An internal turbine is disposed within the central pipe. The internal turbine is configured to rotate in response to gravitational flow of the internal working fluid through the central pipe. As water flows through the central pipe, the internal turbine is configured to rotate at a second speed, or second RPM value that is higher than the first RPM value.

In one aspect, the tubular body is connected in two portions to the central pipe. A first portion serves as a first tank and is positioned on one end of the central pipe, while a second portion serves as a second tank and is positioned on an opposing end of the central pipe. Because the two portions form a single helical fluid circuit, a single volume of working fluid resides within the tubular body. The volume of working fluid flows cyclically into and out of each of the tank portions as the hydrokinetic turbine is turned, flowing through the central pipe once in each direction during each cycle.

In a second embodiment, a double helical arrangement is provided. In this arrangement, the tubular body defines four separate tank portions wherein a first volume of fluid resides within the first and third tank portions, while a separate second volume of fluid resides within second and fourth tank portions. This may be done through two separate tubular bodies residing in parallel, each having their own central pipe.

Alternatively, a single separate pipe utilizing check valves and separate flow channels may be provided to facilitate the gravitational movement of working fluid from tanks in the upper position to tanks in the lower position.

In either instance, the tubular body is configured to allow the first and second volumes of internal working fluid to drain from upper tank portions into the central pipe(s). As the internal working fluids pass through the central pipes, internal turbines are turned at high speed in order to generate electricity before draining into the lower tanks. Passing working fluid through the central pipes occurs twice per rotation.

In any embodiment, the first RPM may be between about 0.25 and about 2.50, inclusive, and the second RPM may be between about 100 and 1,000, inclusive. In an alternate embodiment, the first RPM ranges from about 0.50 to 1.50, and the second RPM ranges from about 500 to 800. In yet another embodiment, the first RPM ranges from about 2.50 to 10.00, and the second RPM ranges from about 700 to 5,000. The first RPM may be as high as 20 RPMs, while the second RPM may be as high as 10,000 RPMs.

The hydrokinetic turbine further includes a plurality of check valves, wherein each check valve is configured to direct internal working fluid in a single direction in response to gravitational forces. In one aspect, the hydrokinetic turbine offers a first check valve that is configured to direct internal working fluid from the first tank to the central pipe. The turbine also has a second check valve that directs internal working fluid from the central pipe back to the first tank. The first and second check valves may reside at opposing ends of the first tank.

A third check valve is also present. The third check valve is configured to direct internal working fluid from the second tank into the central pipe. This aspect also includes a fourth check valve that directs internal working fluid from the central pipe to the second tank. The third and fourth check valves are disposed at opposing ends of the second tank.

The hydrokinetic turbine additionally provides an internal shaft that is mechanically coupled to the internal turbine such that rotation of the internal turbine causes rotation of the internal shaft at about the same RPM as the internal turbine. The internal shaft extends out of the central pipe and is mechanically coupled to a generator. The generator produces electricity in response to rotation of the internal shaft. Preferably, the generator is equipped with a power cable that is configured to transmit electrical output from the generator.

The hydrokinetic turbine may be brushless, or may include a plurality of slip rings and a plurality of electrical brushes. The plurality of slip rings may be configured to rotate with the tubular body. The slip rings receive electrical output from the power cable. The electrical brushes do not rotate, but remain stationary and receive electrical output from the slip rings. In one aspect, the electrical output is eventually transmitted to a remote power station, electrical grid, or an isolated distribution system. The power station, electrical grid, or isolated distribution may be floating or may be located onshore.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of a water turbine of the present invention, in one embodiment. This view is generally taken from the front of the water (or “hydrokinetic”) turbine.

FIG. 2 is another perspective view of the water turbine of FIG. 1. This view is generally taken from the side of the water turbine, with the water turbine in its upright position.

FIG. 3A is a perspective view of a water turbine in accordance with a second embodiment of the present invention. This embodiment employs two separate tubular bodies residing in parallel.

FIG. 3B is a top view of the water turbine of FIG. 3A.

FIG. 3C is a side view of the water turbine of FIG. 3A.

FIG. 4 is a schematic view of a tubular body of the water turbines shown in FIG. 1 or FIG. 3A, demonstrating a direction of working fluid flow within a tubular body.

FIGS. 5A through 5F present schematic views of the progressive flow of internal working fluid through the tubular body of a rotating water turbine in accordance with the present invention.

In FIG. 5A, the tubular body is stationary and has not begun spinning. Arrows indicate a direction of the flow of fluid upon rotation of the tubular body.

In FIG. 5B, the tubular body has spun clockwise 10° from FIG. 5A.

In FIG. 5C, the tubular body is rotated about 30° with respect to FIG. 5A.

In FIG. 5D, the tubular body has rotated 60° from the orientation of FIG. 5A.

In FIG. 5E, the tubular body has spun 120° with respect to FIG. 5A.

In FIG. 5F, the tubular body is rotated a full 180° as compared to FIG. 5A.

FIG. 6 is a schematic view of the water turbine of the present invention, in one embodiment. Opposing blades and internal components of the tubular body and are shown.

FIG. 7 is a top schematic view of a water turbine system as installed on the floor of a body of water, such as a river bed. Various illustrative mooring lines are shown.

FIG. 8 is a side schematic view of the water turbine of FIG. 6.

FIG. 9 provides a side schematic view of the central pipe of FIG. 8. The series of arrows represents the flow of internal working fluid through the central pipe during rotation of the water turbine.

### DETAILED DESCRIPTION OF CERTAIN EMBODIMENTS

### Definitions

As used herein, the term “fluid” refers to gases, liquids, and combinations of gases and liquids. The term “fluid” may refer to water or other aqueous fluid.

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The singular forms “a”, “an” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly “an example,” “exemplary” and the like are understood to be non-limiting terms.

The terms “substantially” or “about” allow for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “helical” and “helical design” are intended to include any geometry that is helix-like, including a series of linear tubular bodies connected together by corner tubes.

The terms “comprising” and “including” and “having” and “involving” (and similarly “comprises”, “includes,” “has,” and “involves”) and the like as found in the Specification are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations or aspects. Thus, for example, “a process involving steps a, b, and c” means that the process includes at least steps a, b and c. Wherever the terms “a” or “an” are used, “one or more” is understood, unless such interpretation is nonsensical in context.

### DESCRIPTION OF SPECIFIC EMBODIMENTS

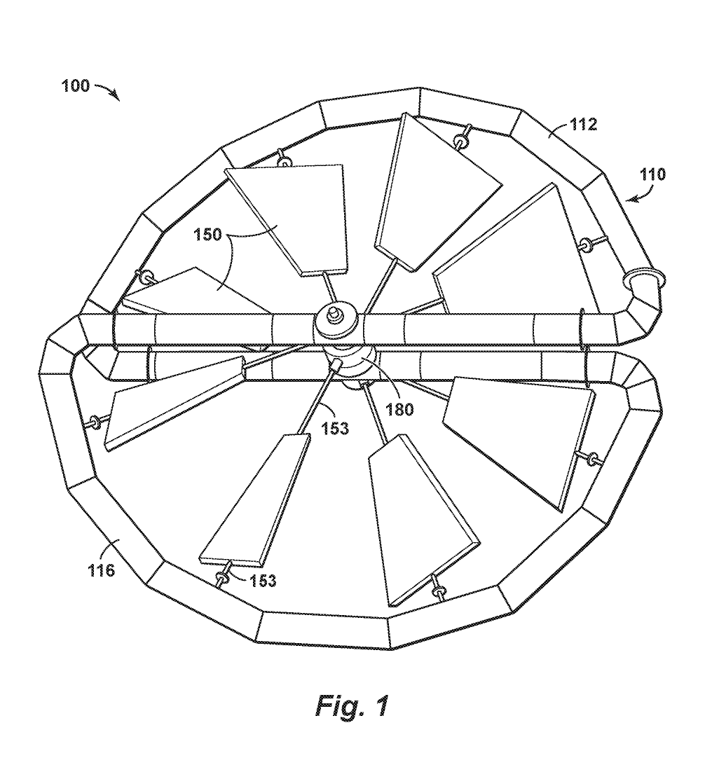

FIG. 1 is a perspective view of a water turbine 100 of the present invention, in one embodiment. This view is generally taken from the front of the water turbine 100. The turbine 100 is designed to operate within a large body of water having a current. Non-limiting examples include an ocean, a river or a deep tidal basin.

The turbine 100 includes a tubular body 100. The tubular body is designed to hold a working fluid, which is preferably an aqueous liquid. In the illustrative arrangement of FIG. 1, tubular body 110 is configured to have a generally circular profile. However, other profiles that afford a closed fluid circuit may be employed.

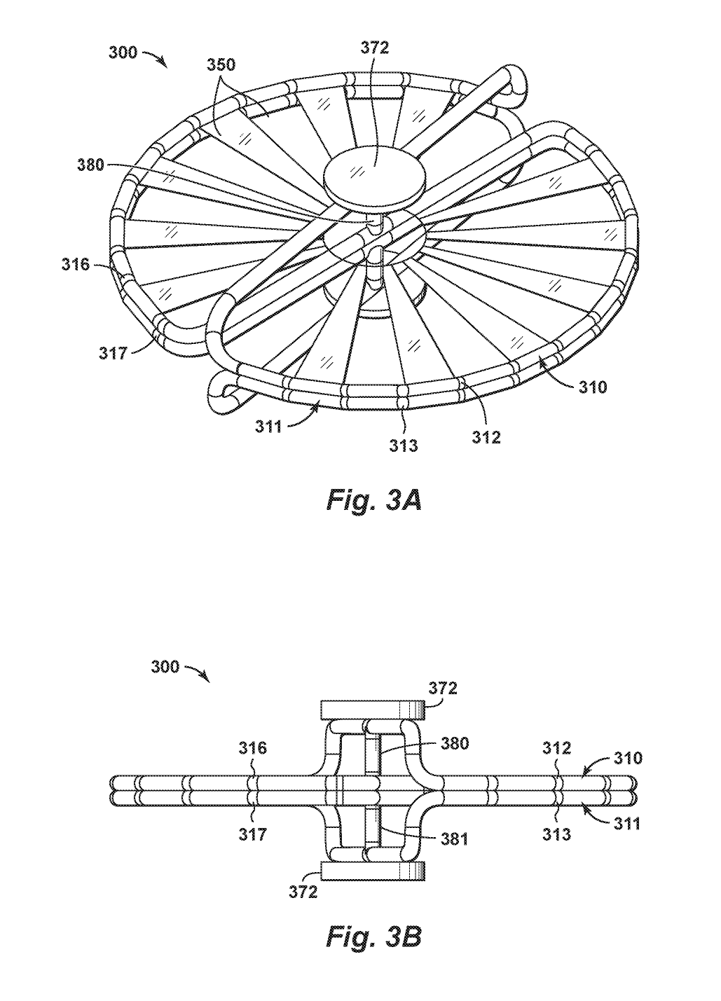

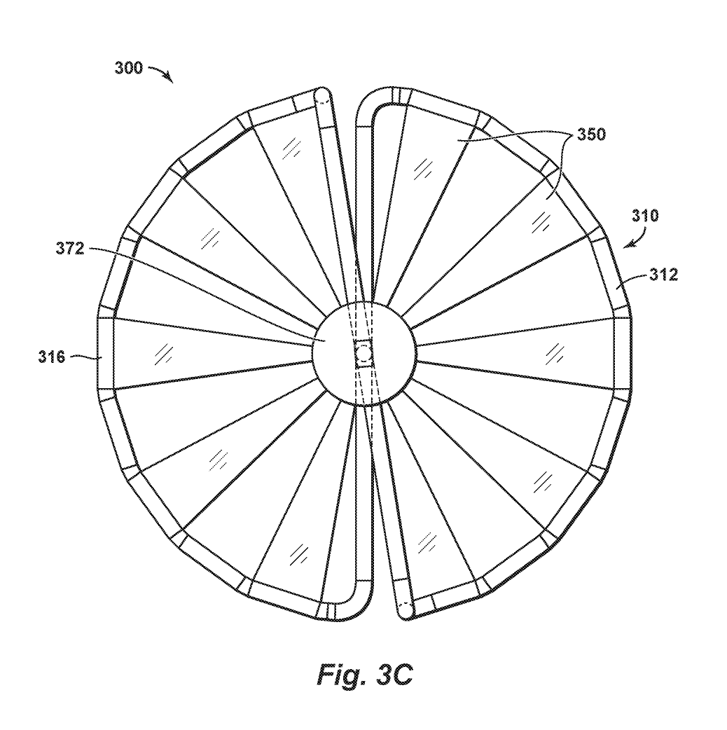

It is further observed that the tubular body 100 has a helical design. In the view of FIG. 1, the tubular body 100 forms a single helical design. However, as shown in connection with the FIG. 3 series below, a double or even triple helical design may also be employed.

It is understood that when the term “helical” or the phrase “helical design” are used herein, such captures any geometry that is helix-like. From a mathematical standpoint, unless all of the turns in a pipe are of a circular nature and have the same radius, the pipe is not truly a helix. However, for purposes of the present disclosure any closed fluid circuit in the form of a helix or “FIG. 8” is considered helical, including a series of straight pipes connected by elbows to approximate a helical path.

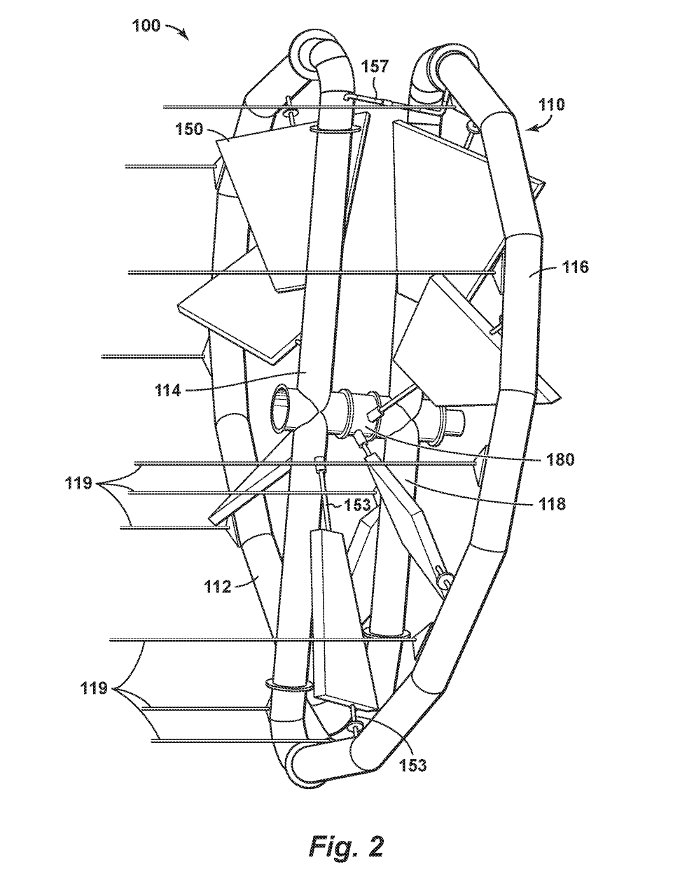

At the center of the tubular body 110 is a central pipe 180. The central pipe 180 is seen best in FIGS. 2, 8, and 9, described below. The central pipe 180 serves as an axle about which the tubular body 110 turns, or “spins,” in response to hydrokinetic energy. The central pipe 180 also serves as a fluid channel through which working fluids pass between portions of the helical tubular body 110.

In the view of FIG. 1, a plurality of blades (or “vanes”) 150 is shown. The vanes 150 extend radially from a center region of the tubular body 110. Each blade 150 is tethered to the central pipe 180 or other portion of the tubular body 110 in a central region via one or more vane supports 153. Separate vane supports 153 extend from the blades 150 out to the tubular body 110 to provide support.

In the arrangement of FIG. 1, the tubular body 110 comprises a pair of helical tanks 112, 116. The first 112 and second 116 helical tanks, or “tank portions,” are in fluid communication with one another by means of the central pipe 180. A pair of cross beams (seen in FIG. 2 at 157) that continue transversely across the diameter of the tubular body 110 may be employed to provide lateral support for the two tanks 112, 116.

FIG. 2 provides a perspective view taken from the side of the water turbine 100. The central pipe 180 is clearly seen between the first 112 and second tanks 116 forming the tubular body 110. In addition, the helical shape of the tubular body 110 in this embodiment is more clearly visible. The blades 150 can also be seen extending radially from the central pipe 180, although some blades 150 are affixed to the tubular body 110 at locations near a central region of the water turbine 100.

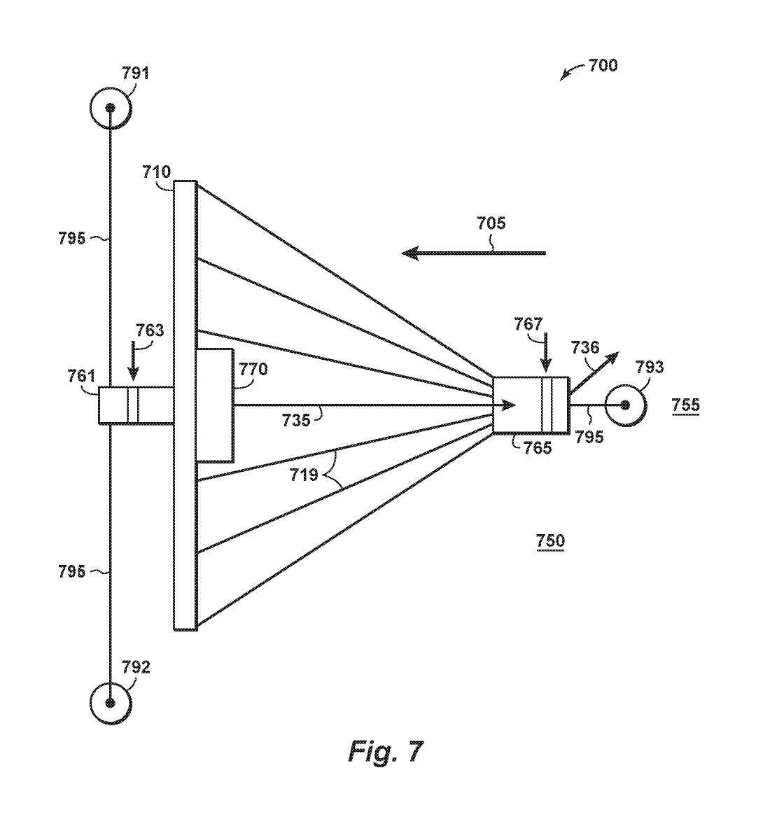

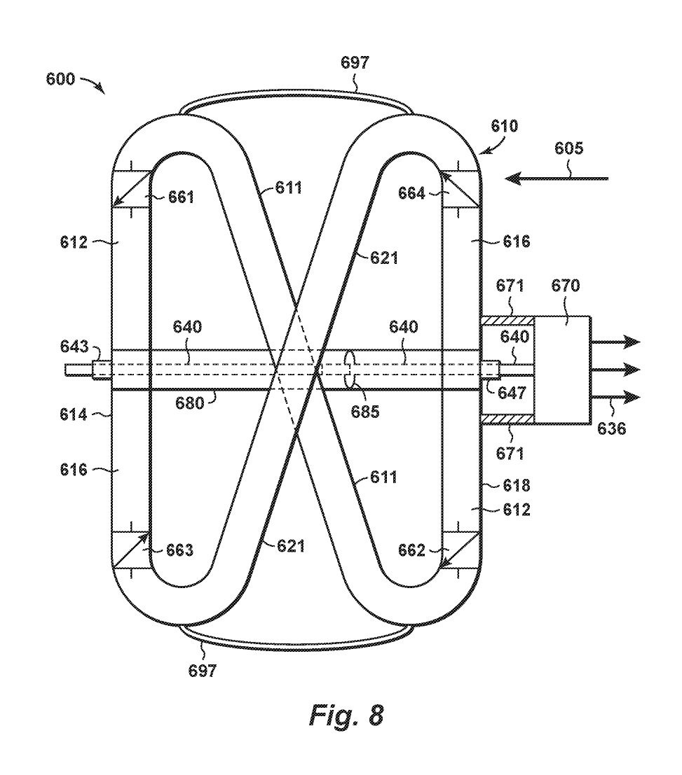

The pair of crossbeams 157 that connect the tubular body 110 to the central pipe 180 are more clearly visible in the view of FIG. 2. A plurality of cables 119 can also be seen extending from corresponding anchor points disposed along the tubular body 110. These cables 119 link to a connection housing (shown in FIG. 7 at 765) that rotates with the water turbine 100. The anchor points may be along a fixed structure such as an oil rig or a bridge, but more preferably are at the ocean floor or river bed as the case may be. The water turbine 100 may also be indirectly anchored such as by tethering to one or more buoys.

In operation, the water turbine 100 shown in FIGS. 1 and 2 is fully submerged in a body of water such as a river, an ocean or tidal basin. In another instance, the water turbine 100 may be tethered within a man-made lake just upstream from a hydro-electric dam. Water currents or tidal motions within the body of water act on the blades 150 to rotate the water turbine 100. The large size of the water turbine 100 allows for the generation of a substantial amount of energy as the turbine 100 slowly rotates.

The construction and operation of known hydrokinetic turbines rely on traditional mechanisms of power transmission and speed change, such as gears and chains. As noted above, this becomes increasingly challenging and expensive as the turbine grows in size up to capacities attractive for commercial use. In contrast, the hydrokinetic turbines described herein become more efficient with increasing size, making turbine diameters of 50 feet, 100 feet, or even 250 feed practical and attractive options for providing power for commercial use.

In one aspect, the diameter of the water turbine 100 is small and ranges from five to fifty feet. In another aspect, the diameter of the hydrokinetic turbine ranges from ten to forty feet. Alternatively, the diameter of the turbine may be between fifteen and thirty feet. In one embodiment, the diameter of the hydrokinetic turbine is up to 100 feet. For marine applications in an ocean such as the Gulf of Mexico, it is preferred that the diameter of the water turbine 100 be as large as 250 feet.

As discussed above, traditional turbine systems are unable to harness this energy due to the torque that is generated by a slowly rotating turbine wheel. For example, using the horsepower equation defined above, and assuming a rotation speed of one RPM, a 1,000 watt generator, which is equivalent to 1.34 horsepower, generates an overwhelming 7,040 foot-pounds of torque. However, running the same generator at 1,000 RPM generates only 7.040 foot-pounds of torque.

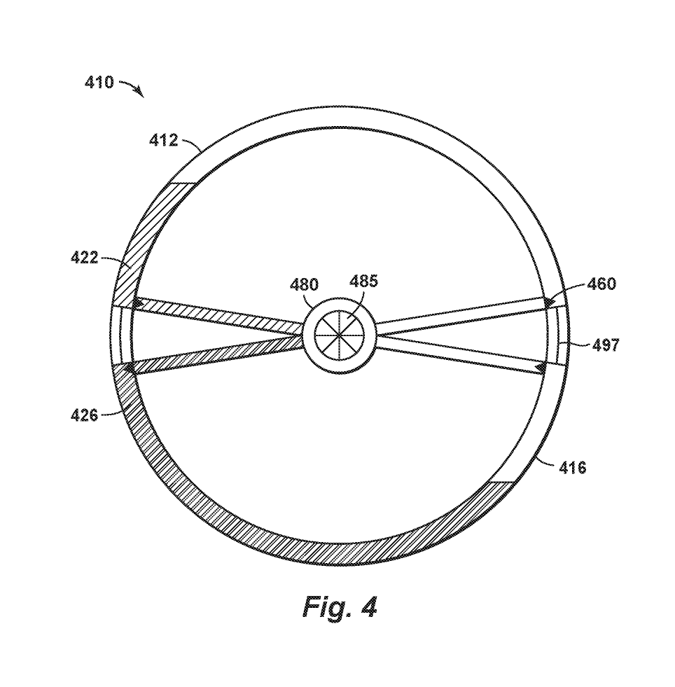

As discussed in more detail below, the present invention achieves a high RPM through rotation of a secondary, internal turbine (485 and 685 of FIGS. 4, 5A-5F, 6, 8, and 9) that is driven by the action of gravitational forces on an internal working fluid (shown in FIGS. 4, 5A-5F, and 9). Briefly, in the aspect shown in FIGS. 1 and 2, the tubular body 110 is partially filled with the internal working fluid. The first 112 and second 116 tanks 112 along the helical frame hold the working fluid and form a fluid circuit through which the working fluid flows during rotation of the tubular body 110.

As the water turbine 100 rotates at a low RPM, one of the two tanks 112 or 116 becomes elevated. In response, the internal working fluid falls from the elevated tank to flow through the central pipe 180. The flow of working fluid through the central pipe 180 drives the internal turbine 485 at a high RPM. After driving the internal turbine 485, the working fluid gravitationally drains into the lower of the two tanks.

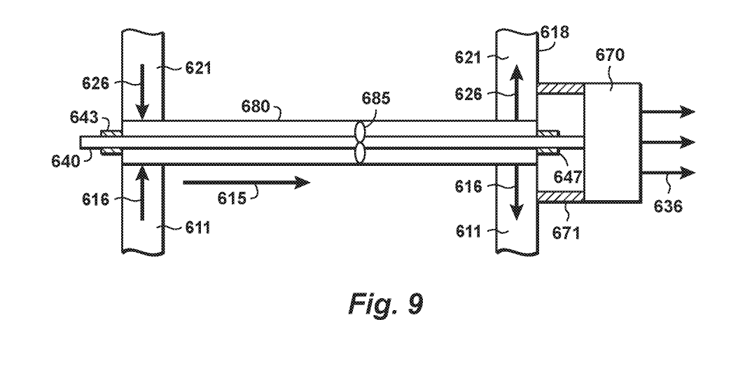

The internal turbine 485 is connected to a generator (shown at 670 in FIGS. 8 and 9). The generator 670 harnesses the resultant and substantial electrical energy. Power in the form of electrical output may then be transmitted to a remote power station, electrical grid, or an isolated distribution system via a power cable or other means (such as power cable 736 of FIG. 7).

In the arrangement of FIGS. 1 and 2, the first 112 and second 116 fluid tanks each define a single tube connected to the central pipe 180. However, it is feasible to employ two or more tubes in generally parallel relation. Where two parallel tubular bodies are used, four separate fluid tank portions are provided.

FIG. 3A is a perspective view of a water turbine 300 in accordance with a second embodiment of the present invention. In this aspect, a first tubular body 310 and a second tubular body 311 are provided, side-by-side, each tubular body comprising a central pipe 380, 381 (more clearly visible in FIG. 3B). The tubular bodies 310, 311 are generally helical in shape. The first tubular body 310 is connected in two portions 312, 316 to the first central pipe 380. The second tubular body 311 is connected in two portions 313, 317 to the second central pipe 381.

A plurality of blades 350 extend radially from a center region of the tubular bodies 310, 311. A first generator box 372 is shown connected to the central pipe 380 of the first tubular body 310.

FIG. 3B is a side view of the water turbine 300 of FIG. 3A. The first central pipe 380 and the second central pipe 381 are shown in the center of the water turbine 300. The first generator 372 associated with the first tubular body 310 is seen at the top of FIG. 3B In addition, a second generator 373 associated with the second tubular body 373 is located at the bottom of FIG. 3B. The use of two generators 372, 373 potentially doubles the electrical wattage generated by rotation of the water turbine 300 as compared to water turbine 100.

FIG. 3C is a side view of the water turbine 300 of FIG. 3A. Only the first tubular body 310 is visible from this view, the second tubular body 311 being disposed behind the first tubular body 310. Once again, the first generator 372 is shown at the center of the first tubular body 310.

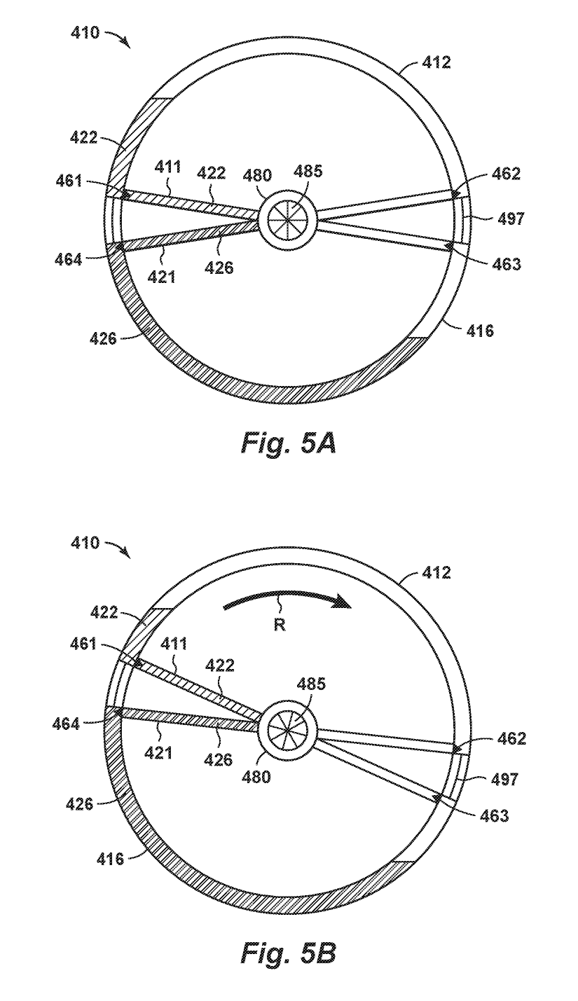

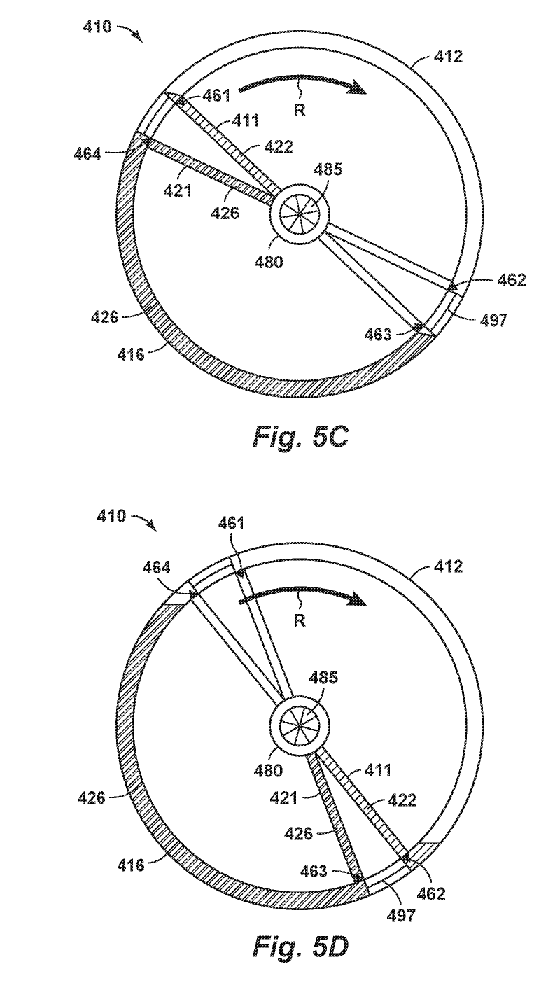

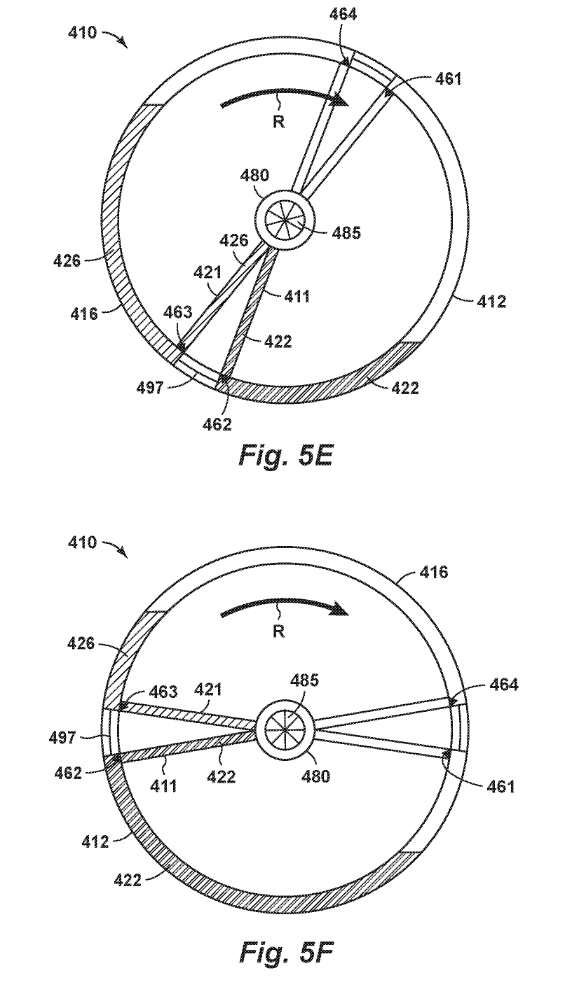

In operation, each of the tubular bodies 310, 311 is partially filled with an internal working fluid (shown in FIGS. 4, 5A-5F, and 9). Preferably, the same fluid composition is used as the working fluid for each of the tubular bodies 310, 311. The working fluid is held within each of the portions 312, 313, 316, and 317, which serve as tanks to hold the fluid disposed therein. As discussed in more detail below, the internal working fluid is used to drive separate internal turbines (shown at 485 in FIGS. 4 and 5A-5F) as the water turbine 300 rotates.

The internal turbine residing within central pipe 380 includes an output shaft that extends into electrical generator 372. Similarly, the internal turbine residing within central pipe 381 includes an output shaft that extends into electrical generator 373. Rotation of the shafts turns corresponding shafts with the respective generators 372, 373 to generate electrical power.

The benefit of the water turbine 300 arrangement of FIGS. 3A-3C is that one set of blades 350 is now able to turn two sets of tubular bodies 310, 311, causing working fluid to flow through two separate central pipes 380, 381 in parallel. This, in turn, generates electricity from two separate internal generators 485. Depending on scale, the internal generators of the water turbine 300 are able to generate almost twice as much electricity as the single internal generator of the turbine 100.

It is observed that while FIGS. 3A-3C present the use of two separate tubular bodies 310, 311 partially filled with an internal working fluid and each forming its own closed fluid circuit, a third tubular body also partially filled with an internal working fluid and forming its own closed fluid circuit could be added. In this instance, a third central pipe having a third internal turbine would be provided. There is no limit to the number of helix-sections that can be used should a larger number of sections prove to be advantageous.

FIG. 4 is a schematic view of a tubular body 410 in accordance with an embodiment of the present invention. FIG. 4 shows the tubular body 410 without associated vanes to allow for clear visualization of the tubular body 410.

As with the tubular body 110 of water turbine 100, the tubular body 410 of FIG. 4 presents two tank portions. These are indicated at 412 and 416. The first 412 and second 416 tanks are in fluid communication by means of a central pipe 480, forming a fluid circuit. The fluid circuit is 50% to 60% filled with the working fluid at all times. However, depending on rotational position each tank 412, 416 may have a different percentage of its respective volume filled with the working fluid.

A first volume of internal working fluid 422 is shown in a portion of the tubular body 410 that forms the first tank 412. Similarly, a second volume of internal working fluid 426 is shown in a portion of the tubular body 410 that forms the second tank 416. The internal working fluid 422, 426 is fluidically sealed from the body of water in which the tubular body 410 of an associated water turbine is submerged, or at least substantially submerged.

It is noted that four check valves 460 are used along the tubular body 410. The check valves 460 operate to control the direction of flow of the internal working fluid 422, 426 in a single direction through the tubular body 410, including the central pipe 480. The arrows of the respective check valves 460 indicate the direction of fluid flow through the valves 460 within the central pipe 480. Of interest, the check valves will work regardless of which way the tubular body 410 spins in response to current.

Air bypass lines 497 are seen between the two tanks 412, 416. In operation, the air bypass lines 497 allow for gas to pass from a tank that is filling 416 to a tank that is draining 412.

An internal turbine 485 is also shown in FIG. 4. The internal turbine 485 is disposed along the path of flow for working fluid as it passes from one tank to the other. It is understood that the turbine 485 will have its own turbine blades (not shown). It is further understood that the turbine 485 will include a generator output shaft, a rotor, a stator, and likely a wicket gate or other device used for fluid flow control. The current inventions are not limited to the configuration of the internal turbine 485 so long as the internal turbine 485 is configured to reside within the central pipe 480 and capture hydrokinetic energy and convert it to electricity.

In the arrangement of FIG. 4, the tubular body 410 comprises first 412 and second 416 helical tanks that are in fluid communication with one another by means of the central pipe 480. In this arrangement a single closed fluid circuit is provided. (This is unlike the arrangement of FIG. 3A where two closed fluid circuits are provided, side-by-side, essentially sharing an axle. However, it is understood that the tubular body 410 could comprise third and fourth helical tanks having a separate central pipe along the same longitudinal axis as central pipe 480 and still forming a single closed fluid circuit. In this instance, two separate internal turbines may again be employed.

FIGS. 5A through 5F present side, cut-away views of the tubular body 410 of FIG. 4 in series. The views of FIGS. 5A through 5F may also be representative of the tubular body 110 of FIGS. 1-2 or either of the tubular bodies 310 and 311 of FIGS. 3A-3C.

FIG. 5A is a repetition of FIG. 4. In FIG. 5A, the tubular body 410 is in a beginning position. At this point, the first tank 412 is located substantially above the second tank 416. A first portion of the internal working fluid 422 is shown within the first tank 412, and a second portion of the internal working fluid 426 is shown within the second tank 416. Air bypass lines 497 are once again shown between the two tanks 412, 416. In addition, four check valves 461, 462, 463 and 464 are indicated.

In FIG. 5B, the water turbine has now begun spinning. In this view, the tubular body 410 is rotated about 10° from FIG. 5A. Rotation occurs in a clockwise direction, as indicated by arrow “R”. However, it is understood that the blades (such as blades 150 of FIG. 1) may be configured to cause rotation of the tubular body 410 in a counter-clockwise direction.

It is noted that when a turbine, such as turbine 100 of FIG. 1, placed in a body of water, the current within the body of water will typically flow in only one direction. This is true when the body of water is a river or ocean. However, if the body of water is a deep tidal basin, then the turbine will have periods within a 24-hour cycle when the turbine is spinning in a clockwise direction, periods when the turbine is spinning in a counter-clockwise direction, and periods in between when the turbine is hardly moving at all.

Returning to FIG. 5B, as the tubular body 410 rotates the region of the first tank 412 holding the first portion of internal working fluid 422 becomes elevated. As a result of this elevation, the first portion of internal working fluid 422 falls gravitationally through a first check valve (CV1) 461. A third check valve (CV3) 463 prevents the first portion of working fluid 422 from directly entering the second tank 416. As a result, the first portion of internal working fluid 422 is routed through the cross beam 411 and substantially through the central pipe 480, wherein the fluid 422 drives the internal turbine 485. (See FIG. 9 for a detailed view of internal working fluid 611, 626 passing through the central pipe 680 to drive an internal turbine 685). The first portion of the internal working fluid 422 then joins the second portion of internal working fluid 426 and passes through the cross beam 421 and across the fourth check valve (CV4) 464 to enter the second tank 416.

In FIG. 5C, the water turbine has rotated about 30° as compared to FIG. 5A. A marked reduction in the first portion of internal working fluid 422 is visible as the fluid 422 drains gravitationally from the first tank 412 and enters the central pipe 480 to drive the internal turbine 485. The draining of the first tank 412 through the central pipe 480 fills the second tank 416 to a near maximal level as the first portion of working fluid 422 merges with the second portion 426.

In FIG. 5D, the water turbine has rotated about 60° with respect to FIG. 5A. In this orientation, the second tank 416 approaches a vertical position such that gravitational forces act on the second portion of internal working fluid 426 to direct the fluid through CV3 463. The second portion of the internal working fluid 426 then enters the cross beam 421 of the second tank 416. CV1 461 prevents internal working fluid from back-flowing from the central pipe 480 into the first tank 412. As a result, as the tubular body 410 rotates the second portion of the internal working fluid 426 will be directed entirely through the central pipe 480 to drive the internal turbine 485 before draining into the crossbeam 411 of the first tank 412 and joining the first portion of the internal working fluid 422.

In FIG. 5E, the tubular body 410 of the water turbine has rotated about 120° with respect to the alignment of FIG. 5A. Continued rotation of the tubular body 410 causes the internal working fluid 426 of the second tank 416 to drain from the second tank 416 through the central pipe 480 to propel the high-speed, internal turbine 485 and into the first tank 412. In this orientation, a relatively equal volume of internal working fluid is distributed between the first tank 412 and the second tank 416. CV2 462 prevents the flow of internal working fluid 422 back out of the cross beam 411 of the first tank 412.

In FIG. 5F, the water turbine has rotated a full 180° as compared to FIG. 5A. The first tank 412 is now disposed directly underneath the second tank 416, and the majority of the second portion of internal working fluid 426 has transferred through the central pipe 480 to join the first portion of internal working fluid 422.

It is noted here that the location of the four check valves (CV1, CV2, CV3 and CV4) may be adjusted. In the views of FIGS. 5A-5F, the check valves 461, 462, 463, 464 are shown along radial portions of the first 412 and second 416 tanks. However, the check valves 461, 462, 463, 464 in an alternate arrangement may be positioned more closely to the central pipe 480 along crossbeams 411 and 421.

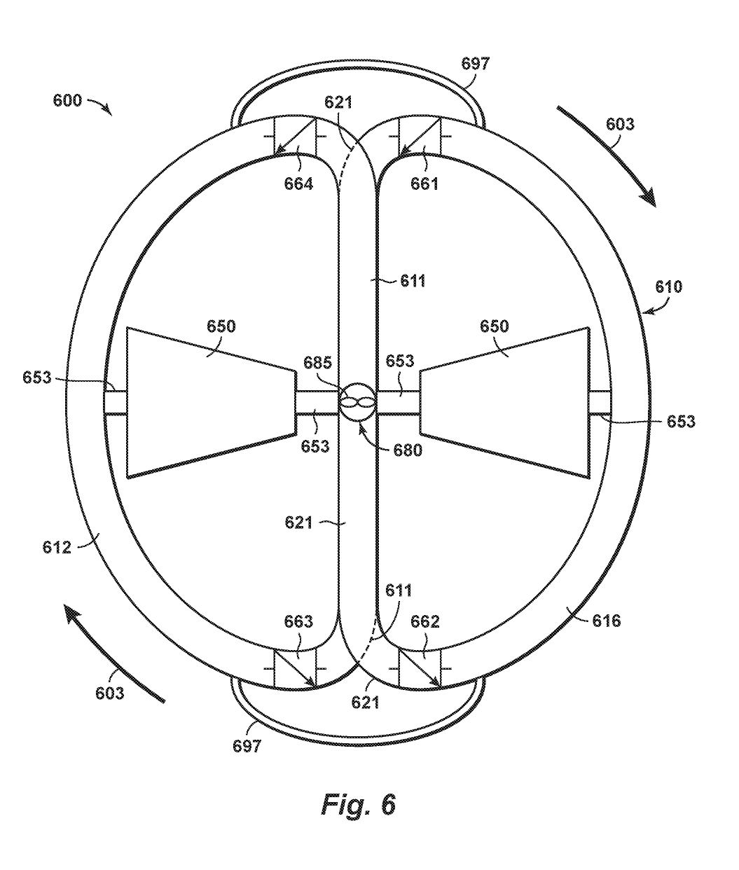

FIG. 6 is a schematic view of a water turbine 600 of the present invention, in yet another embodiment. This view shows the front of the water turbine 600. A pair of blades, or vanes 650, is shown mounted to the tubular body 610 via vane supports 653. An internal turbine 685 is shown within a central pipe 680, wherein the central pipe 680 extends “out of the page.” The portion of the tubular body 610 serving as a first tank 612 is oriented to the left of FIG. 6, while the portion of the tubular body 610 serving as a second tank 616 is oriented to the right of the figure.

Water turbine 600 also includes four check valves, indicated as 661, 662, 663 and 664. The check valves 661, 662, 663, 664 are positioned lateral to the crossbeams of the tubular body 610. Water turbine 600 also includes a pair of bypass air lines 697. The air lines 697 are shown at the top and bottom of the tubular body 610.

Two crossbeams continue transversely across the diameter of the tubular body 610 (seen more clearly in FIG. 2). The dashed lines that are partially visible along a first crossbeam 611 signify that the first crossbeam 611 lies directly behind the second crossbeam at the bottom of the figure, indicating the helical shape of the water turbine 600 embodiment of FIG. 6 (as seen more clearly in FIGS. 1 and 2). At the top of the figure, the second crossbeam 621 lies behind the first crossbeam 611. Similarly, at the bottom of the figure the first crossbeam 611 lies behind the second crossbeam 621.

In operation, the water turbine 600 of FIG. 6 is fully submerged within a body of flowing water, such as a large flowing river, a tidal basin, or an ocean. Water currents or tidal motions (arrow 705 in FIG. 7) act on the blades 650 of the water turbine 600 to cause slow rotation of the water turbine 600 in the direction of radial arrow 603. This rotational movement causes internal working fluid (shown at 422 and 426 of FIGS. 5A-5F) disposed within the tubular body 610 to cyclically enter the central pipe 680 and drive the internal turbine(s) 685 at a high RPM.

Mechanical energy generated through the slow rotation of the water turbine 600 is captured by an output shaft (not visible in FIG. 6) and converted into electrical energy. Similarly, rotation of vanes (not shown) within the internal turbine 685 is converted into electrical energy. In both cases, electrical output is harnessed and sent through electrical lines (not shown) as an electrical power feed. It is understood that the electricity generated by internal turbine 685 will be much higher than electricity generated by rotation of the water turbine 600, and the operator may opt to capture only the energy from the internal turbine 685.

FIG. 7 is a top schematic view of a water turbine system 700 as installed on the floor of a body of water 750. The direction of water currents or tidal motion is shown at arrow 705. Three anchor points 791, 792, and 793 secure the system 700 to the floor of the body of water 750.

The water turbine system 700 includes a water turbine 710. The water turbine 710 is in accordance with any of the hydrokinetic turbines 100, 300 or 600 described above. Thus, the water turbine 710 will include a large, helical (or, optionally, double-helical) tubular body that holds a volume of working fluid. A first thrust bearing 763 is shown coupled to a first connection housing 761. The connection housing 761 will comprise a shaft (not shown) that is bearingly connected to the thrust bearing 763 on one end, and fixedly is attached to the back of the water turbine 710 at the opposite end. Thus, the connection housing 761 turns with the water turbine 710.

A plurality of cables 719 extend from the front of the water turbine 710 to a second connection housing 765. The second connection housing 765 is coupled to a second thrust bearing 767. The connection housing 765 also comprises a shaft (not shown) that is bearingly connected to the thrust bearing 767 on one end, and is fixedly attached to the cables 710 at the opposite end. Thus, the second connection housing 765 also turns with the water turbine 710.

In operation, the first bearing 763 and the second thrust bearing 767 work in concert to allow the water turbine 710 and associated components to rotate as the blades (seen at 150, 350, and 650 of FIGS. 1, 2, 3A-3C, and 6) of the water turbine 710 are driven by the flow of water currents 705. Thus, in the FIG. 7 aspect, all components medial to the first bearing 763 and second bearing 767 rotate with the water turbine 710. In contrast, all components lateral to the bearings 763, 767 remain stationary and are tethered to the floor of the body of water via the associated anchors 791, 792, 793 and corresponding mooring lines 795.

A generator housing 770 is shown attached to the front of the water turbine 710. A multi-conductor power cable 735 extends from a generator within the generator housing 770 to the second connection housing 765. The power cable 735 transfers electrical energy from the generator housing 770 and through the second connection housing 765. The power generated from the generator within the housing 770 is then transmitted out of the system 700 to a station onshore (not shown) or to a floating station (not shown) via power cable 736, where the generated power is further directed for consumption.

The first and second connection housings 761, 765 each comprise seals that prevent the water in which the water turbine 110 is submerged from entering the turbine system. In one aspect, the second housing 765 comprises a plurality of slip rings that serve to transfer power from the rotating water turbine 710 to a plurality of stationary electrical brushes, thereby communicating electrical current. Power from the generator 770 is transmitted by the multi-conductor cable 735. Power may be transmitted through the slip rings which rotate at the same speed as the main water turbine 710. The non-rotating electrical brushes physically contact the slip rings, thereby permitting power from a rotating source to be transmitted to the shore or a floating station via cable 736.

It is understood that the water turbine 710 also includes a small, internal turbine, such as turbine 685 in FIGS. 6 and 8. The generator housing 770 serves primarily to convert mechanical energy from the rotating output shaft (seen at 640 in FIG. 8) of the internal turbine 685 into electrical power, which is then transmitted through cables 735 and 736.

As will be evident to one of skill in the art, the number of slip rings and electrical brushes required will vary proportionally with the energy output. The thrust bearing 767 and slip ring assembly may or may not be underwater. In some aspects, the first bearing 763 connected to the cables at the first and second anchor points 791, 792 is underwater. Preferably, the whole of the rotating components of the water turbine system 710 is submerged.

In any event, the generated power can be connected to the electrical grid or used to power an isolated distribution system. Examples of a power distribution system include the electrical systems for an offshore oil rig, or for a floating FPSO, or for an offshore power station for marine vessels, or for an offshore power station for a floating offshore research facility or a military installation. In one aspect, the generated power is used to maintain a charge for batteries associated with marine vessels or floating structures.

FIG. 8 provides a side schematic view of the water turbine 600 of FIG. 6. Arrow 605 denotes the direction of hydrokinetic flow through the water turbine 600. The blades 650 have been removed from FIG. 8 to allow for ease of viewing of the turbine's components.

As seen more clearly here, the central pipe 680 functionally divides the tubular body 610 into the first tank 612 and the second tank 616. The check valves 661, 662, 663, 664 are shown within the lateral portions of the two crossbeams 611, 621 of the tubular body 610. The internal turbine 685 surrounds a drive shaft 640. The drive shaft 640 extends through the central pipe 680 and into a generator 670, which is physically tethered to the front of the tubular body 610 via a pair of generator supports 671. Of course, it should be understood that the generator 670 may be disposed at the back of the tubular body 610 or at any practical location along the water turbine 600 so long as it is mechanically engaged to the drive shaft 640.

In an alternate aspect, the generator 670 may be separate from the tubular body 610. In one aspect, the generator 670 is disposed within or on one of the connection housings 761, 765.

In the embodiment of FIG. 8, seals and bearings 643, 647 are positioned where the drive shaft 640 exits the tubular body 610. Electrical output 636 is shown exiting the generator 670. The electrical output 636 represents power to be transmitted out of the water turbine system. Preferably, electrical output is carried through a multi-use electrical cable such as cable 735 shown in FIG. 7, and then away from the water turbine 600 through the power cable 736.

FIG. 9 is a side schematic view showing the central pipe 680 of FIGS. 6 and 8 and a cut-away portion of the two crossbeams 611, 621 of the tubular body 610. The series of arrows 615, 616, and 626 represent the flow of internal working fluid through the central pipe 680. The internal turbine 685 is more clearly seen surrounding the drive shaft 640 within the central pipe 680. As mentioned above, a seal 643, 647 exists at both ends of the central pipe 680, where the drive shaft 640 exits the tubular body 610. These seals 643, 647 prevent fluid from entering or leaving the tubular body 610.

Referring to FIGS. 6, 8, and 9 together, as the water turbine 600 slowly rotates CV1 661 or CV3 663, depending upon which tank 612, 616 is at the higher elevation, directs the internal working fluid 616 or 626 into the central pipe 680. Once in the central pipe 680, the internal working fluid 615 flows toward the internal turbine 685 and eventually exits the central pipe 680. CV2 662 or CV4 664 then directs the internal working fluid 616 or 626 to refill the empty tank 612 or 616. The process continues as the water turbine 600 rotates, causing a constant flow of working fluid through the central pipe 680. This flow will cause the internal turbine 685 to turn at a very rapid rate. Thus, gravitational forces acting on the internal working fluid 615 allow the relatively low speed of water currents or tidal motion to produce a high speed internal fluid flow that, in turn, rotates the internal turbine 685 at a high RPM.

The rotation of the internal turbine 685 spins the drive shaft 640, which, in turn, drives the high speed generator 670 to harness substantial electrical power through cable 736. In this way, the present invention permits the use of large hydrokinetic turbines or water wheels without requiring expensive speed step up components, such as unwieldy gearboxes.

In one aspect of the present invention, the shaft of the large water turbine rotates at about 0.25 to 10 RPMs, inclusive, depending on the speed of the current. The internal turbine may rotate at a speed between about 100 and about 10,000 RPMs, inclusive. In another embodiment, the turbine rotates at between 1.0 and 5.0 RPMs while the internal turbine may be configured to rotate at between 500 and 800 RPMs. Preferably, the large water turbine rotates at about 5.0 RPMs, and the internal turbine rotates at about 5,000 RPMs.

Preferably, the hydrokinetic turbine includes a first tubular body and a second tubular body as provided in FIG. 3A. Both the first tubular body and the second tubular body are substantially helical in shape, and each tubular body has a central pipe and a high speed internal turbine. In such an embodiment, the second helical tubular body is dimensioned and configured in accordance with the first helical tubular body, thereby approximately doubling power output.

As can be seen, an improved water turbine is provided. The water turbine of the present invention can be scaled such that it actually improves efficiency with increasing size. The water turbine captures hydrokinetic energy to lift an internal working fluid residing within a tubular, helical body. Gravitational forces act on the working fluid within this closed circuit to spin an internal turbine at very high RPMs, which drives a high speed electrical generator. Importantly, this hydrokinetic water turbine system operates with little or no carbon footprint and requires no fuel cost. All that is required is a strong water current.

The water turbine is designed to generate electrical power continuously in the presence of naturally-occurring or man-made water flow to produce electricity. Therefore, the water turbine of the present invention is capable of producing electrical energy 24 hours a day, 7 days a week, and 365 days a year Beneficially, the electrical generator may be designed to work regardless of the direction in which the water current is flowing. This is particularly beneficial when the water turbine is placed along a deep tidal basin.

A method is also disclosed, in accordance with various embodiments of the present general inventive concept, for generating electrical power through the use of a hydrokinetic turbine.

The method first includes submerging a hydrokinetic turbine, as discussed throughout this disclosure, within a flowing body of water, and anchoring the hydrokinetic turbine in the body of water with at least two mooring lines. The flowing body may be a river, an ocean (including a sea), a tidal basin, or any other body of water that has water currents or tidal motion. The hydrokinetic flow is then allowed to act on two more blades to rotate the tubular body at a first RPM value. Rotating at the first RPM causes the internal working fluid to flow gravitationally through the central pipe. While flowing through the central pipe, the internal working fluid rotates an internal turbine at a second RPM value that is higher than the first RPM value. The rotation of the internal turbine generates electrical power.

As the hydrokinetic turbine rotates, the method further provides for allowing a first volume of internal working fluid to at least partially drain from a first tank of the tubular body and into the central pipe. After rotating the internal turbine at the second, higher RPM value, the first volume of internal working fluid is allowed to substantially drain from the central pipe into the second tank. Upon draining into the second tank, the first volume of internal working fluid joins the second volume of internal working fluid.

The method additionally includes further rotation of the tubular body at the first RPM value as dictated by the water currents. The additional rotation of the tubular body causes the second volume of internal working fluid to at least partially drain from the second tank of the tubular body into the central pipe. After rotating the internal turbine at the second, higher RPM value, the second volume of internal working fluid is allowed to substantially drain from the central pipe and back into the first tank. Upon draining into the first tank, the second volume of internal working fluid joins the first volume of internal working fluid. Thus, the process of passing internal working fluid through the central shaft to drive an internal turbine continuously produces energy while the hydrokinetic turbine is submerged in flowing water.

The method also includes providing a plurality of check valves, wherein each valve directs the internal working fluid in a single direction through the helical (or helix-like) tubular body in response to gravitational forces. In one aspect, a first check valve directs the internal working fluid from the first tank to the central pipe. A second check valve is also used to direct the internal working fluid from the central pipe to the first tank. A third check valve is provided that directs the internal working fluid from the second tank into the central pipe. A fourth check valve is also provided to direct the internal working fluid from the central pipe to the second tank.

For the harnessing of electrical energy, the method also includes providing an internal shaft that is mechanically coupled to the internal turbine. Rotation of the internal turbine causes a reciprocal rotation of the internal shaft. A generator that is mechanically coupled to the internal shaft is also provided, such that rotation of the internal shaft causes the generator to produce an electrical output. The electrical output from the generator may be transmitted via a power cable. Optionally, an external shaft associated with the central pipe of the large water turbine is also coupled to a separate generator. Thus, rotation of the external shaft causes the separate generator to produce an additional electrical output that may be transmitted via the power cable.

The method optionally further includes transmitting the electrical power output(s) to a plurality of slip rings that rotate with the tubular body. A plurality of electrical brushes contact the plurality of rotating slip rings, which allows the electrical output to be transferred to the electrical brushes. Power in the form of electrical output may then be transmitted through the brushes to a remote power station, electrical grid, or an isolated distribution system via a cable or other source that may be appropriate for such transmission.

Variations of the present hydrokinetic water turbine may fall within the spirit of the claims, below. For example, as part of the method, the operator may desire to optimize the volume of working fluid within the tubular body as a percentage of the entire volume. This may take into account fluid temperature, fluid density variations, water current velocity and turbine design (including weight of the tubular body). The operator may also optimize the number and angular orientation of the vanes extending from a central region of water turbine.

It will be appreciated that the inventions are susceptible to modification, variation and change without departing from the spirit thereof.

What is claimed is:

1. A hydrokinetic turbine, comprising:
a helical tubular body;
two or more blades configured to rotate the tubular body at a first RPM value in response to a hydrokinetic flow within a body of water;
a central pipe in fluid communication with the tubular body, forming a fluid circuit;
an internal working fluid that is disposed and fluidically sealed within the fluid circuit;
an internal turbine that is disposed within the central pipe, wherein the internal turbine is configured to rotate at a second RPM value that is higher than the first RPM in response to gravitational flow of the internal working fluid through the central pipe during rotation of the tubular body;
an internal shaft disposed along the central pipe configured to rotate with the internal turbine, and extending from the central pipe; and
a first generator that is mechanically coupled to the internal shaft, such that rotation of the internal shaft causes the first generator to produce a first electrical output.

2. The hydrokinetic turbine of claim 1, wherein:
the tubular body is connected as a first portion and a second portion to opposing ends of the central pipe; wherein
the first portion of the tubular body serves as a first tank configured to hold a first volume of the internal working fluid,
the second portion of the tubular body serves as a second tank configured to hold a second volume of the internal working fluid, and
the first tank, the second tank and the central pipe together form the fluid circuit.

3. The hydrokinetic turbine of claim 2, wherein:
the internal working fluid is an aqueous fluid;
the tubular body is configured to allow the first volume of internal working fluid to gravitationally drain from the first tank into the central pipe as the first tank is rotated into an upper position over the central pipe; and
the second tank is configured to receive the first volume of internal working fluid after the first volume of internal working fluid passes through the central pipe such that the first volume of fluid combines with the second volume of fluid.

4. The hydrokinetic turbine of claim 3, wherein:
the tubular body is configured to allow the second volume of internal working fluid to gravitationally drain from the second tank back into the central pipe as the second tank is rotated into an upper position over the central pipe; and
the first tank is configured to receive the second volume of internal working fluid after the second volume of internal working fluid passes through the central pipe such that a substantial portion of the second volume of fluid becomes the first volume of fluid;
and wherein the internal turbine and internal shaft rotate to generate electricity whether the central pipe is receiving working fluid from the first tank or from the second tank.

5. The hydrokinetic turbine of claim 4, further comprising:
a plurality of check valves, wherein each valve is configured to direct internal working fluid through the fluid circuit in a single direction in response to gravitational forces.

6. The hydrokinetic turbine of claim 5, wherein:
a first check valve is configured to direct internal working fluid from the first tank to the central pipe as the first tank is rotated into an upper position over the central pipe;
a second check valve is configured to direct internal working fluid from the central pipe to the first tank as the second tank is rotated into an upper position over the central pipe;
a third check valve is configured to direct internal working fluid from the second tank into the central pipe as the second tank is rotated into an upper position over the central pipe; and
a fourth check valve is configured to direct internal working fluid from the central pipe to the second tank as the first tank is rotated into an upper position over the central pipe.

7. The hydrokinetic turbine of claim 5, further comprising:
at least two mooring lines anchored in the water body and operatively connected to the hydrokinetic turbine to maintain the hydrokinetic turbine in a substantially submerged state.

8. The hydrokinetic turbine of claim 5, wherein:
the first RPM value is between about 0.25 and about 2.50, inclusive; and
the second RPM value is between about 100 and about 5,000, inclusive.

9. The hydrokinetic turbine of claim 5, wherein:
the first RPM value is between about 0.50 and about 1.50, inclusive; and
the second RPM value is between about 500 and about 800, inclusive.

10. The hydrokinetic turbine of claim 5, wherein:
the two or more blades comprise vanes that reside equi-distantly about a central region of the tubular body; and
the hydrokinetic turbine further comprises vane supports that secure the respective vanes to the central pipe or the tubular body.

11. The hydrokinetic turbine of claim 10, wherein the vanes comprise 6 or more vanes.

12. The hydrokinetic turbine of claim 5, wherein:
the first tank, the second tank and the central pipe form a helical body;
the hydrokinetic turbine further comprises:
an external shaft wherein mechanical rotation of the central pipe in the body of water, in turn, rotates the external shaft; and
a second generator that is mechanically coupled to the external shaft, such that rotation of the external shaft causes the second generator to produce a second electrical output.

13. The hydrokinetic turbine of claim 12, wherein the hydrokinetic turbine further comprises:
the first generator and the second generator; and
a power cable configured to transmit the first and second electrical outputs to an onshore power station, an electrical grid or a floating electrical distribution system.

14. The hydrokinetic turbine of claim 13, further comprising:
a plurality of slip rings; and
a plurality of electrical brushes;
wherein
the plurality of slip rings are configured to rotate with the tubular body, and are further configured to receive the electrical output from the first and second generators; and
the plurality of electrical brushes are configured to remain stationary and are further configured to receive electrical output from the plurality of slip rings and transmit electrical energy to the power cable.

15. The hydrokinetic turbine of claim 1, wherein:
the first electrical output is transmitted to a remote power station, an electrical grid, or an isolated distribution system.

16. The hydrokinetic turbine of claim 1, wherein the body of water is an ocean, a river, a tidal basin, or a lake formed by a dam.

17. The hydrokinetic turbine of claim 1, wherein:
the helical tubular body comprises a first helical tubular body and a second helical tubular body, residing side-by-side, each of which is configured to carry its own internal working fluid;
each of the first and second tubular bodies comprises its own first tank, its own second tank, and its own central pipe connecting the respective first and second tanks, forming respective first and second fluid circuits;
each of the first and second tubular bodies is configured to rotate together at the first RPM value in response to the hydrokinetic flow;
each of the central pipes contains a respective internal shaft configured to rotate with a corresponding internal turbine.

18. The hydrokinetic turbine of claim 17, wherein (i) the first generator is mechanically coupled to each of the internal shafts, such that rotation of the internal shafts causes the first generator to produce the first electrical output.

19. A method of generating electrical power through the use of a hydrokinetic turbine comprising:
providing a hydrokinetic turbine that comprises:
a helical tubular body;
two or more vanes configured to rotate the tubular body;
a central pipe in fluid communication with the tubular body, forming a fluid circuit;
an internal working fluid that is disposed and fluidically sealed within the tubular body; and
an internal turbine that resides within the central pipe;
submerging the hydrokinetic turbine in a body of water having a hydrokinetic flow; and
allowing the hydrokinetic flow to act on the two more vanes to rotate the tubular body at a first RPM value, wherein:
rotation of the tubular body causes the internal working fluid to flow gravitationally through the central pipe and to rotate the internal turbine at a second RPM value that is higher than the first RPM in response to gravitational flow of the internal working fluid through the central pipe, and
rotation of the internal turbine generates electrical power.

20. The method of claim 19, wherein the hydrokinetic turbine further comprises:
an internal shaft disposed along the central pipe configured to rotate with the internal turbine, and extending from the central pipe; and
a first generator that is mechanically coupled to the internal shaft, such that rotation of the internal shaft causes the first generator to produce a first electrical output as at least part of the electrical power.

21. The method of claim 20, wherein:
the tubular body is connected as a first portion and a second portion to opposing ends of the central pipe; wherein
the first portion of the tubular body serves as a first tank that holds a first volume of the internal working fluid,
the second portion of the tubular body serves as a second tank that holds a second volume of the internal working fluid; and
the first tank, the second tank and the central pipe together form the fluid circuit.

22. The method of claim 21, wherein:
the internal working fluid is an aqueous fluid; and
the method further comprises:
allowing the first volume of internal working fluid to gravitationally drain from the first tank into the central pipe in response to rotation of the tubular body, wherein the first volume of working fluid rotates the internal turbine; and
allowing the first volume of internal working fluid to then drain from the central pipe into the second tank, thereby joining the second volume of internal working fluid.

23. The method of claim 22, further comprising:
continuing to rotate the tubular body such that the second tank is rotated into an upper position over the central pipe;
allowing the second volume of internal working fluid to gravitationally drain from the second tank back into the central pipe, wherein the second volume of internal working fluid then rotates the internal turbine; and
allowing the second volume of internal working fluid to then drain from the central pipe into the first tank, thereby joining the first volume of internal working fluid;
and wherein the internal turbine and internal shaft rotate to generate electricity whether the central pipe is receiving working fluid from the first tank or from the second tank.

24. The method of claim 23, further comprising:
a plurality of check valves, wherein each valve directs the internal working fluid in a single direction through the fluid circuit in response to gravitational forces.

25. The method of claim 24, wherein:
a first check valve directs the internal working fluid from the first tank to the central pipe as the first tank is rotated into an upper position over the central pipe;
a second check valve directs the internal working fluid from the central pipe to the first tank as the second tank is rotated into an upper position over the central pipe;
a third check valve directs the internal working fluid from the second tank into the central pipe as the second tank is rotated into an upper position over the central pipe; and
a fourth check valve directs the internal working fluid from the central pipe to the second tank as the first tank is rotated into an upper position over the central pipe.

26. The method of claim 20, further comprising:
anchoring the hydrokinetic turbine in the body of water with at least two mooring lines.

27. The method of claim 20, wherein:
the first RPM value is between about 0.25 and about 2.50, inclusive; and
the second RPM value is between about 100 and about 5,000, inclusive.

28. The method of claim 20, wherein:
the first RPM value is between about 0.50 and about 1.50, inclusive; and
the second RPM value is between about 500 and about 800, inclusive.

29. The method of claim 25, wherein the hydrokinetic turbine further comprises:
an external shaft wherein rotation of the central pipe in turn rotates the external shaft; and
a second generator that is mechanically coupled to the external shaft, such that rotation of the external shaft causes the second generator to also generate electrical power; and
the method further comprises transmitting the electrical power from the first and second generators to an onshore power station, an electrical grid, or a floating electrical distribution system.

30. The method of claim 23, wherein:
the helical tubular body comprises a first helical tubular body and a second helical tubular body residing side-by-side, each of which resides in parallel and each of which is configured to carry its own internal working fluid;
each of the first and second tubular bodies comprises its own first tank, its own second tank, and its own central pipe connecting the respective first and second tanks;
each of the first and second tubular bodies is configured to rotate together at the first RPM value in response to the hydrokinetic flow;
each of the central pipes contains a respective internal shaft configured to rotate with a corresponding internal turbine; and
the first generator is mechanically coupled to each of the internal shafts, such that rotation of the internal shafts causes the first generator to produce the first electrical output.

31. A method of generating electrical power from hydrokinetic energy, comprising:
providing a hydrokinetic turbine that comprises:
a helical tubular body;
two or more blades configured to rotate the tubular body in response to water currents within a body of water;
a central pipe in fluid communication with the tubular body, forming a fluid circuit;
an internal working fluid that is disposed and fluidically sealed within the fluid circuit;
an internal turbine that resides within the central pipe;
a first thrust bearing operatively connected to a front of the helical tubular body, the first thrust bearing being anchored to a floor of the water body by means of at least one mooring line;
a second thrust bearing operatively connected to a rear of the helical tubular body through a plurality of cables, the second thrust bearing also being anchored to the floor of the water body;
submerging the hydrokinetic turbine in the body of water such that the hydrokinetic turbine is exposed to the water currents;
allowing the water currents to act on the two more blades to rotate the tubular body at a first RPM value, wherein:
rotation of the tubular body causes the internal working fluid to flow gravitationally through the central pipe and to rotate the internal turbine at a second RPM value that is higher than the first RPM value in response to gravitational flow of the internal working fluid through the central pipe, and
rotation of the internal turbine generates electrical power.

32. The method of claim 31, wherein:
the first thrust bearing is connected to the front of the helical tubular body through a first housing connection that rotates with the tubular body;
the first thrust bearing is anchored to the floor of the water body by means of at least two mooring lines; and
the second thrust bearing is connected to the plurality of cables by means of a second housing connection;
such that the first bearing and the second thrust bearing work in concert to allow the tubular body to rotate as the blades are acted upon by the water currents.

33. The method of claim 32, wherein the hydrokinetic turbine further comprises:
an internal shaft disposed along the central pipe configured to rotate with the internal turbine, and extending from the central pipe; and
a first generator that is mechanically coupled to the internal shaft, such that rotation of the internal shaft causes the first generator to produce a first electrical output as at least part of the electrical power;
and wherein the method further comprises transmitting the electrical power to an onshore power station, an electrical grid, or a floating electrical distribution system.

34. The method of claim 33, wherein:
the tubular body is connected in a first portion and a second portion to the central pipe; wherein
the first portion of the tubular body serves as a first tank that holds a first volume of the internal working fluid,
the second portion of the tubular body serves as a second tank that holds a second volume of the internal working fluid; and
the first tank, the second tank and the central pipe together form the fluid circuit.

35. The method of claim 34, wherein:
the internal working fluid is an aqueous fluid; and
the method further comprises:
allowing the first volume of internal working fluid to gravitationally drain from the first tank into the central pipe in response to rotation of the tubular body, wherein the first volume of working fluid rotates the internal turbine;
allowing the first volume of internal working fluid to then drain from the central pipe into the second tank, thereby joining the second volume of internal working fluid.
continuing to rotate the tubular body;
allowing the second volume of internal working fluid to gravitationally drain from the second tank into the central pipe as the second take rotates over the first tank, wherein the second volume of internal working fluid then rotates the internal turbine; and
allowing the second volume of internal working fluid to then drain from the central pipe into the first tank, thereby joining the first volume of internal working fluid;
and wherein the internal turbine and internal shaft rotate to generate electricity whether the central pipe is receiving working fluid from the first tank or from the second tank.

36. The method of claim 35, wherein:
the body of water is an ocean;
the water currents are ocean currents; and
the power distribution system comprises electrical systems for an offshore oil rig, a floating FPSO, or an offshore power station for marine vessels.
